(19) United States
(12) Patent Application Publication
(10) Pub. No.: US 2018/0281322 A1
(43) Pub. Date: Oct. 4, 2018

(54) Self-Sealing Vehicle Tyre

(71) Applicant: Continental Reifen Deutschland GmbH, Hannover (DE)

(72) Inventors: Markus Dahlke, Wunstorf (DE); Nadja Schleer, Hannover (DE); Joe Guardalabene, Hannover (DE)

(73) Assignee: Continental Reifen Deutschland GmbH, Hannover (DE)

(21) Appl. No.: 15/762,101

(22) PCT Filed: Jul. 19, 2016
(86) PCT No.: PCT/EP2016/067131

§ 371 Date: Mar. 23, 2018

(30) Foreign Application Priority Data
Oct. 6, 2015 (DE) 10 2015 219 296.2

(51) Int. Cl. B29C 73/16; C09J 11/06; B60C 19/12; B29D 30/06

(52) U.S. Cl. CPC B29C 73/163; C09J 11/06; B29D 2030/0697; B29D 30/0685; B60C 19/122

(57) ABSTRACT

The invention relates to a self-sealing pneumatic vehicle tire having a belt package (2), a tread (1) arranged radially above the belt package (2) and an airtight inner layer (4) arranged radially on the inside, wherein the self-sealing of the pneumatic vehicle tire is obtained via a sealant layer (5) subsequently applied radially on the inside after the vulcanization of the pneumatic vehicle tire, wherein the sealant layer (5) has essentially the width of the belt package (2) and is arranged essentially in the projection thereof and has a cross section which is formed in a cross-sectional plane including the tire axis and has a surface (5a) running essentially parallel to the belt package in axial direction and a surface (5b) running essentially in radial direction.

It is a feature of the invention that at least the surface of the sealant layer (5a) running essentially parallel to the belt package in axial direction has a circumferential coating (6) that contains at least one alkali metal salt of at least one fatty acid and/or at least one alkaline earth metal salt of at least one fatty acid.

The invention relates to a self-sealing pneumatic vehicle tire having a belt package, a tread arranged radially above the belt package and an airtight inner layer arranged radially on the inside, wherein the self-sealing of the pneumatic vehicle tire is obtained via a sealant layer subsequently applied radially on the inside after the vulcanization of the pneumatic vehicle tire, wherein the sealant layer has essentially the width of the belt package and is arranged essentially in the projection thereof and has a cross section which is formed in a cross-sectional plane including the tire axis and has a surface running essentially parallel to the belt package in axial direction and a surface running essentially in radial direction.

Pneumatic vehicle tires of this kind with self-sealing configuration are known, for example, from the applicant's DE 10 2006 059 286 A1. These involve subsequently providing standard tire constructions with a sealant layer. The sealant is a self-adhesive, viscous sealing compound which is applied as a layer from the inside in radial direction in the projection region of the belt package to the radially innermost tire layer, the largely airtight inner layer. The sealant layer is capable of automatically sealing punctures of up to 5 millimeters in diameter. After a puncture through the tread to through the inner layer, the sealant completely surrounds the penetrating foreign body, seals the interior off from the environment and hence prevents loss of compressed air from the tire. The driver of the vehicle is not forced to replace the defective tire immediately with an equivalent replacement wheel or an emergency wheel.

The sealant is used by the applicant under the ContiSeal® name. The sealant is notable for airtightness, high tackiness and balanced flow characteristics.

Owing to the high tackiness of the sealant in the sealant layer, unwanted foreign bodies that get into the interior of the tire (for example during the storage of the tire) stick to the sealant layer, in this context particularly to the surface of the sealant layer directed radially inward. The surface directed radially outward sticks to the inner layer and is therefore not exposed.

Moreover, constituents, such as amines in particular, from the rubber mixtures that surround the sealant layer, especially the inner layer, can react with peroxides and/or free radicals formed thereby (free-radical cleavage products) from the sealant. The amines may especially be tert-butylamine from accelerators such as N-tert-butyl-2-benzothiazylsulfenamide (TBBS). These amines can get to the surfaces of the tire components, especially the internal tire components, through migration and/or through evaporation and subsequent condensation. Especially during the storage of a multitude of tires in a confined space, the concentration of the amines in the air is so high that they condense particularly on the inner surfaces of the tire components.

The peroxides from the sealant may be dibenzoyl peroxide and the corresponding benzoyl radical and/or tert-butyl peroxybenzoate and the corresponding tert-butoxy radical.

The peroxides or free-radical cleavage products thereof can also accumulate particularly on the inner surfaces of the tire components through migration and/or evaporation and subsequent condensation.

These amines and peroxides or free radicals can react with one another, and in this case form unwanted crystals that likewise adhere to the sealant layer in particular.

It is an object of the present invention to provide a self-sealing pneumatic vehicle tire in which no foreign bodies (or only a very small quantity thereof) stick to the sealant layer within the tire and crystal formation on the free surface area within the tire is reduced or even entirely prevented, without any adverse effect on the sealing performance of the sealant.

The object is achieved in accordance with the invention in that at least the surface of the sealant layer running essentially parallel to the belt package in axial direction has a circumferential coating that contains at least one alkali metal salt of at least one fatty acid and/or at least one alkaline earth metal salt of at least one fatty acid.

A coating of this kind firstly lowers the tackiness of the surface of the sealant layer directed radially inward to such a significant degree that (virtually) no unwanted foreign bodies stick to the sealant layer.

Secondly, the alkali metal salt and/or alkaline earth metal salt of at least one fatty acid on the sealant layer reduces the extent of the reaction between amines from adjacent rubber mixtures and peroxides or free radicals formed thereby (free-radical cleavage products thereof) from the sealant, such that there is unwanted crystal formation on the coated sealant layer only to an insignificant degree, if at all.

The pneumatic vehicle tire of the invention additionally does not have any impairment with regard to the self-sealing properties.

Preferably, the coating is applied in the form of an aqueous suspension, in which case at least a majority of the water present in the suspension evaporates, leaving a coating containing at least one alkali metal salt of at least one fatty acid and/or at least one alkaline earth metal salt of at least one fatty acid.

In this case, according to the process, not the entire amount of the water is evaporated and a residual amount can thus remain in the coating.

In a preferred embodiment of the invention, the coating therefore contains water.

In a further preferred embodiment, the coating contains only very small amounts of water or no water at all, i.e. 0% to 1% by weight of water.

It is essential to the invention that the coating contains one or more salts of fatty acids. This greatly lowers the tackiness of the surface of the sealant layer and reduces or even entirely prevents crystal formation within the tire. At the same time, the sealing performance of the self-sealing pneumatic vehicle tire having such a coating is not adversely affected. Fatty acids are known to the person skilled in the art and, according to Rompp Online® 2015, are “aliphatic, saturated and unsaturated carboxylic acids with an unbranched carbon chain, but for a few exceptions”.

It is particularly preferable in the context of the present invention when the fatty acid has 8 to 18 carbon atoms.

This particularly effectively prevents the above-described reaction of amines with peroxides to give unwanted crystals. The number of 8 to 18 carbon atoms is particularly preferred when the chains are linear unbranched carbon chains.

Preferred fatty acids, or salts thereof as described below, are, for example and especially octanoic acid (also called caprylic acid) having 8 carbon atoms and/or tetradecanoic acid (also called myristic acid) having 14 carbon atoms and/or hexadecanoic acid (also called palmitic acid) having 16 carbon atoms and/or octadecanoic acid (also called stearic acid) having 18 carbon atoms.

In a preferred embodiment of the invention, the fatty acid is selected from the group consisting of octanoic acid and/or tetradecanoic acid and/or hexadecanoic acid and/or octadecanoic acid.

In a particularly preferred embodiment of the invention, the fatty acid is at least octadecanoic acid.

According to the invention, the at least one fatty acid is present in the coating in the form of at least one alkali metal and/or alkaline earth metal salt.

In the context of the present invention, “alkali metal salt of at least one fatty acid” is understood to mean the alkali metal salt of at least one fatty acid, where alkali metals in salts have a formal single positive charge, for example and especially the alkali metal ions of lithium (Li⁺), sodium (Na⁺), potassium (K⁺), rubidium (Rb⁺).

Preferably, the alkali metal ion of the salt is lithium (Li⁺) and/or sodium (Na⁺) and/or potassium (K⁺).

The ions of the fatty acid have a formal single negative charge, such that, in the alkali metal salt of the fatty acid, one alkali metal ion and one ion of the fatty acid (carboxylate ion) in each case correspond to a formal neutral charge.

The at least one alkali metal salt of at least one fatty acid may also be a mixture of different alkali metal salts in which the alkali metals and/or the fatty acids are the same or different than one another. The same applies to the at least one alkaline earth metal salt of at least one fatty acid. This too may be a mixture in which the alkaline earth metals and/or fatty acids are the same or different than one another.

In the context of the present invention, “alkaline earth metal salt of at least one fatty acid” is understood to mean the alkaline earth metal salt of at least one fatty acid, where alkaline earth metals in salts have a formal double positive charge, for example and especially the alkaline earth metal ions beryllium (Be²⁺), magnesium (Mg²⁺), calcium (Ca²⁺), etc. Preferably, the alkaline earth metal ion of the salt is magnesium (Mg²⁺) and/or calcium (Ca²⁺), more preferably calcium (Ca²⁺).

In the alkaline earth metal salt of the fatty acid, one alkaline earth metal ion and two ions of the fatty acid correspond to a formal neutral charge.

In a preferred embodiment of the invention, the coating contains at least one alkali metal salt of at least one fatty acid and at least one alkaline earth metal salt of at least one fatty acid.

In a particularly preferred embodiment of the invention, the alkaline earth metal salt of at least one fatty acid is at least calcium stearate.

A suitable aqueous suspension containing calcium stearate and at least one alkali metal salt of at least one fatty acid is available, for example, under the Rhenodiv® BO 7672-1 trade name from Rheinchemie.

A suspension of this kind, prior to the application and drying, contains 58% to 65% by weight of water, 10% to 20% by weight of at least one alkali metal salt of at least one fatty acid, 10% to 20% by weight of calcium stearate and less than 2% by weight of additives or impurities.

In the context of the present invention, the expression “essentially” in the description of the arrangement of the individual components of the pneumatic vehicle tire of the invention means that customary slight production-related variations are included.

The sealant layer has essentially the width of the belt package.

The sealant layer is arranged essentially in the projection thereof (the projection of the belt package), meaning that it runs radially within the belt package essentially parallel thereto. The sealant layer has a cross section which is formed in the cross-sectional plane including the tire axis and has a surface running essentially parallel to the belt package in axial direction and a surface running essentially in radial direction.

The sealant layer preferably has essentially a rectangular cross section, and may have curvature according to the configuration of the tire dimensions, especially in projection of the shoulder edges of the belt package.

The sealant layer is bounded by the inner layer in the radially outward direction and by its surface directed radially inward that runs in axial direction, essentially parallel to the belt package, in the radially inward direction, and is bounded on either side, preferably essentially symmetrically, by the surfaces that run in radial direction, essentially at right angles to the belt package.

In order to effectively lower the tackiness of the sealant layer (on the surface directed radially inward and hence exposed to the inside), the coating is applied at least to the surface of the sealant layer directed radially inward, which runs essentially parallel to the belt package, in a circumferential manner.

Since the surface of the sealant layer directed radially inward, which is thus exposed to the inside, is typically rough, in a preferred embodiment of the invention, the coating has a thickness of 0.01 to 1 mm, more preferably 0.05 to 0.15 mm. Such a thickness assures the lowering of the tackiness even in the case of minor unevenness of the surface of the sealant layer, and this also effectively prevents crystal formation. At the same time, given such a thickness, not too great an amount of the coating (suspension) is applied, such that the tire weight and hence the rolling resistance characteristics of the pneumatic vehicle tire of the invention are not significantly impaired.

The figure for the thickness of the coating represents the thickness measured in radial direction at right angles to the axial extent of the sealant layer.

It is conceivable here that the thickness of the coating in axial direction varies by 0 to 0.005 mm.

In a preferred development of the invention, at least the surface that runs in radial direction, essentially at right angles to the belt package, additionally has the coating as described above. This means both lateral surfaces of the sealant layer running in radial direction (to the left and right in the cross section explained above).

In this way, the entire exposed surface of the sealant layer is coated and the lowering of the tackiness and the prevention of crystal growth (as described above) is thus effective over the entire region of the sealant layer, i.e. in the lateral regions of the sealant layer as well. Preferably, the coating is applied here to the surface of the sealant layer running in radial direction in such a way that there is an overlap with the inner layer on either side in axial direction.

The axial width of the overlap on each side is preferably 0.5 to 10 mm, preferably 0.5 to 2 mm, more preferably 1 mm. In this embodiment, the coating is thus, over the entire surface area of the sealant layer and on each side, in a section of the inner layer that directly adjoins the sealant layer and has a width in axial direction of 0.5 to 10 mm, preferably 0.5 to 2 mm, more preferably 1 mm.

This particularly effectively prevents adhesion of foreign bodies at the sides of the sealant layer as well, and formation of any crystals there too.

Especially through evaporation and subsequent condensation of amines and peroxides or free-radical cleavage products thereof (as described above), it is also possible for crystals to form on the two lateral inner tire walls.

In this case, the substances mentioned may, for example, already have evaporated prior to the application of the coating to the sealant layer and may subsequently have precipitated on the two lateral inner tire walls. Moreover, especially in a tire warehouse, it is also possible for substances to evaporate from other (adjacent) vehicle tires and to condense within the tire.

In a further preferred embodiment of the invention, therefore, the surface directed radially inward, and hence the surface exposed on the inside, of the inner layer additionally has the coating described above.

The surface of the inner layer directed radially outward adheres to the tire components that adjoin the inner layer on the outside in the radial direction, and is therefore not exposed.

By virtue of the inner layer within the tire also having been coated with the coating described above, crystal growth at the two lateral inner tire walls is also prevented. Preferably, the coating in this case extends on either side as far as the radially outward end of the extent of the bead core. Thus, the coating is preferably not applied where the pneumatic vehicle tire of the invention rests on the wheel rim or is in contact with the wheel rim in order to avoid slippage between the tire and wheel rim in the contact area. In this embodiment, when the tire rests on the wheel rim, the entire inner surface area of the pneumatic vehicle tire thus preferably has seamless circumferential coating.

This can be visualized, inter alia, in that the sealant layer and the inside of the tire are covered with a gray haze.

For the purposes of a simple production method for the pneumatic vehicle tire of the invention, the thickness of the coating on the surface of the inner layer is the same as on the surface of the sealant layer.

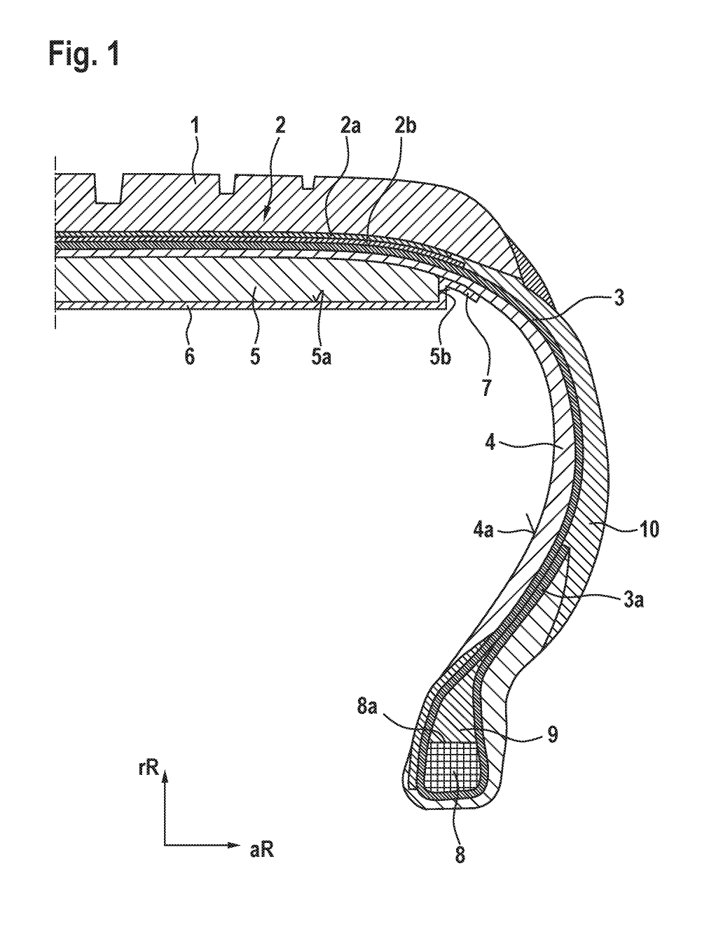

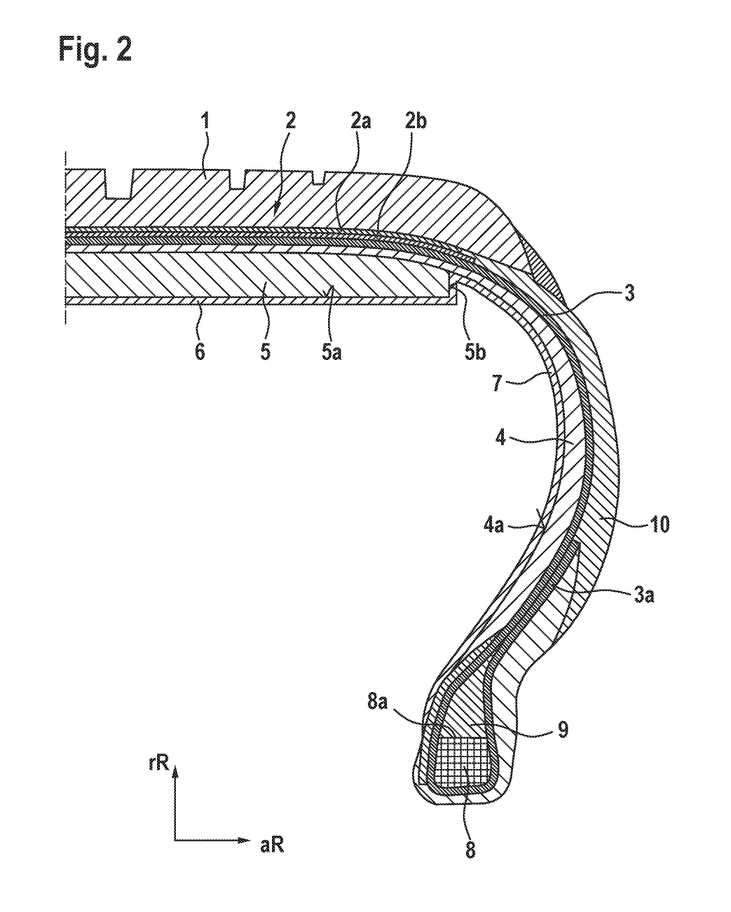

Further features, advantages and details of the invention will be discussed in detail with reference to FIGS. 1 and 2, which illustrate schematic working examples.

The essential constituents of which the self-sealing tire of the invention is composed are a profiled tread 1, a belt package 2 that consists of two layers 2a, 2b in the execution shown, a single-ply carcass 3 which is guided around the bead cores 8 and bead fillers 9 from the inside outward in axial terms and ends in the carcass turnup 3a, and side walls 10. The two plies 2a, 2b of the belt package 2 consist of reinforcing elements of steel cord that are embedded in a rubber compound and run parallel to one another within each ply, the steel cords of the one ply 2a being oriented in a crossing arrangement in relation to the steel cords of the second ply 2b and each forming an angle between 15° and 45° with the circumferential direction of the tire. The single-ply carcass 3 may also be formed in a conventional and known way, and consequently have reinforcing yarns of a textile material or of steel cord that are embedded in a rubber compound and run in the radial direction. The self-sealing of the pneumatic vehicle tire is obtained by means of a sealant layer 5 subsequently applied circumferentially on the inside in radial direction after the vulcanization of the pneumatic vehicle tire. The sealant layer 5 has essentially the width of the belt package 2 and is arranged essentially in the projection thereof and has a cross section which is formed in the cross-sectional plane including the tire axis and has a surface 5a running essentially parallel to the belt package in axial direction and a surface 5b running essentially in radial direction. The surface 5b is present on either side in axial direction and thus constitutes the lateral boundaries of the sealant layer around the circumference.

The sealant layer 5, in the example in FIG. 1, on the surface 5a running essentially parallel to the belt package in axial direction and additionally on the surface 5b running essentially in radial direction, has the coating 6 containing at least one alkali metal salt of at least one fatty acid and/or at least one alkaline earth metal salt of at least one fatty acid. For example, the coating contains at least one alkali metal salt of at least one fatty acid and at least one alkaline earth metal salt of at least one fatty acid, where the alkaline earth metal salt of at least one fatty acid is at least calcium stearate. For example, the fatty acid is selected from the group consisting of octanoic acid and/or tetradecanoic acid and/or hexadecanoic acid and/or octadecanoic acid.

In addition, the coating overlaps the inner layer on either side in axial direction, where the overlap 7

at each side is 0.5 to 10 mm, preferably 0.5 to 2 mm, more preferably, for example, 1 mm.

The thickness of the coating 6 is preferably 0.01 to 1 mm, especially and for example 0.05 to 0.15 mm, more preferably 0.1 mm.

A self-sealing pneumatic vehicle tire of this kind can be obtained, for example, by first producing the pneumatic vehicle tire and then applying the sealant layer as known in the prior art and then applying an aqueous suspension containing at least one alkali metal salt of at least one fatty acid and/or at least one alkaline earth metal salt of at least one fatty acid, for example Rhenodiv® BO 7672-1 from Rheinchemie, to all the exposed surfaces of the sealant layer and a region of the inner layer on each side in axial direction of width 0.5 to 10 mm, preferably 0.5 to 2 mm, more preferably, for example, 1 mm, and drying it.

The sealant layer 5, in the example in FIG. 2, on the surface 5a running essentially parallel to the belt package in axial direction and additionally on the surface 5b running essentially in radial direction and additionally on the surface of the inner layer 4a directed radially inward, has the coating 6 containing at least one alkali metal salt of at least one fatty acid and/or at least one alkaline earth metal salt of at least one fatty acid.

The coating 6 has been applied to the inner layer 4a, for example and with preference, such that it extends, on the surface of the inner layer 4a directed radially inward, from the sealant layer 5 on either side as far as the radially outer end of the extent of the bead core 8a.

A self-sealing pneumatic vehicle tire of this kind can be obtained, for example, by first producing the pneumatic vehicle tire and then applying the sealant layer as known in the prior art and then applying an aqueous suspension containing at least one alkali metal salt of at least one fatty acid and/or at least one alkaline earth metal salt of at least one fatty acid, for example Rhenodiv® BO 7672-1 from Rheinchemie, to all the exposed surfaces of the sealant layer and the surface of the inner layer exposed in the radially inward direction as far as the radially outward end of the extent of the bead core, and drying it.

### LIST OF REFERENCE SIGNS

### Part of the Description

1 Tread
2 Belt package
2a Belt ply
2b Belt ply
3 Carcass
3a Carcass turnup
4 Inner layer
4a Surface of the inner layer directed radially inward
5 Sealant layer
5a Surface of the sealant layer directed radially inward, running in axial direction, essentially parallel to the belt package
5b Surface of the sealant layer running in radial direction, essentially at right angles to the belt package
6 Coating
7 Overlap
8 Bead core
8a Radially outer end of the extent of the bead core
9 Bead filler
10 Side wall
rR Radial direction
aR Axial direction

1.-10. (canceled)

11. A self-sealing pneumatic vehicle tire comprising a belt package, a tread arranged radially above the belt package, and an airtight inner layer arranged radially on the inside, wherein self-sealing of the pneumatic vehicle tire is obtained via a sealant layer subsequently applied radially on the inside after the vulcanization of the pneumatic vehicle tire, wherein the sealant layer has essentially the width of the belt package and is arranged essentially in the projection thereof and has a cross section which is formed in a cross-sectional plane including the tire axis and has a surface running essentially parallel to the belt package in axial direction and a surface running essentially in radial direction, and wherein at least the surface of the sealant layer running essentially parallel to the belt package in axial direction has a circumferential coating that comprises at least one alkali metal salt of at least one fatty acid, at least one alkaline earth metal salt of at least one fatty acid, or at least one alkali metal salt of at least one fatty acid and at least one alkaline earth metal salt of at least one fatty acid.

12. The self-sealing pneumatic vehicle tire as claimed in claim 11, wherein the coating contains at least one alkali metal salt of at least one fatty acid and at least one alkaline earth metal salt of at least one fatty acid.

13. The self-sealing pneumatic vehicle tire as claimed in claim 11, wherein the fatty acid has from 8 to 18 carbon atoms.

14. The self-sealing pneumatic vehicle tire as claimed in claim 11, wherein at least calcium stearate is present in the coating as alkaline earth metal salt of at least one fatty acid.

15. The self-sealing pneumatic vehicle tire as claimed in claim 11, wherein the coating has a thickness of from 0.01 to 1 mm

16. The self-sealing pneumatic vehicle tire as claimed in claim 11, wherein at least the surface running in radial direction additionally has the coating.

17. The self-sealing pneumatic vehicle tire as claimed in claim 16, wherein the coating has been applied to the surface of the sealant layer such that there is an overlap with the inner layer on either side in axial direction.

18. The self-sealing pneumatic vehicle tire as claimed in claim 17, wherein the axial width of the overlap on each side is from 0.5 to 10 mm.

19. The self-sealing pneumatic vehicle tire as claimed in claim 11, wherein the surface of the inner layer directed radially inward additionally has the coating.

20. The self-sealing pneumatic vehicle tire as claimed in claim 19, wherein the coating on the surface of the inner layer directed radially inward extends from the sealant layer on either side as far as the radially outer end of an extent of a bead core.
